(19) United States
(12) Patent Application Publication
(10) Pub. No.: US 2007/0299850 A1
(43) Pub. Date: Dec. 27, 2007

(54) Voice/Text Memo Synchronized Digital Photo Readers/Frames and Data Accessing Methods

(76) Inventor: Ziqiang Qian, Barrington, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/766,808

(22) Filed: Jun. 22, 2007

Related U.S. Application Data
(60) Provisional application No. 60/805,624, filed on Jun. 23, 2006.

(51) Int. Cl. G06F 17/30

(52) U.S. Cl. 707/10

(57) ABSTRACT

According to principles of the present invention, a digital content (photo or video clip) file can have an associated audio and/or text file that shares the same prefix file name as the content file but with a different suffix file name. These associated files record either voice or text memos of the selected digital content. The invented digital photo reader/frame can play/display those associated memos while showing the digital content. A voice memo will be played as a background audio, and a text memo will be overlapped with the digital content.

### CROSS REFERENCE TO RELATED APPLICATIONS

The present invention claims priority to U.S. Provisional 06/805,624 filed on Jun. 23, 2006.

### FIELD OF THE INVENTION

The present invention relates to digital readers/frames that can generate voice and text based memo files for selected digital contents (photos/video clips), and synchronously play/display the memo files while the associated contents are displaying/playing.

### BACKGROUND OF THE INVENTION

Digital photos are getting more and more popular in recent years while digital cameras are becoming more and more affordable. The biggest advantage of digital cameras over conventional film cameras is their low operation costs. The operation cost of conventional cameras is proportional to the number of photos taken; while the operation cost of digital cameras is a one-time memory card expense since memory cards are reusable.

To display digital photos, people either print them out or show them on computer screens. Printed digital photos are easy to review, but they require photo printers, photo papers, and color inks. The cost of photo papers and inks are proportional to the number of prints, which is similar to the cost structure for processing conventional camera films. Some printed photos are framed for putting on desks or hanging on the wall. Since a traditional photo frame typically holds a signal photo, only a few photos will be actually framed and displayed in this way. Storing digital photos on computer hard drives and displaying pictures on computer screens is a cheap way to show digital photos, that is why most of the digital photos are not in printed formats. But it is not convenient to share photos on computer screens because most of the computers are personal devices, which are not designed for non-computer owners or users to access (because it requires knowing the password and having computer skills). To overcome this problem, digital readers/frames are invented.

A typical digital photo frame looks like a traditional photo frame. It is equipped with an LCD screen, a dedicated photo decoding circuitry, memory card slots, and/or onboard memories. It reads digital photos from either memory cards or onboard memories. Most of the digital frames also have remote controllers, audio/video decoders, and speaker systems. A digital photo frame can read and/or store many photos (depending on memory capacities), which can be shown one after another sequentially or randomly. Image transition effects may also be provided. Most digital frames can also play audio/video clips, such as MP3 or MP4.

Digital photo frames are relatively expensive because of the LCD screens. To minimize the cost, a cheap solution, called digital photo reader, is made to show photos on TV screens. This approach takes almost the identical circuitry modules and functions as a digital frame has except it only outputs TV signals without a built-in LCD screen. Some TV set manufacturers have integrated this solution within their TV products for digital photo displays.

When people review a photo, they always try to recall the date, the scene, and the location when or where the photo was taken. The photo related information is easily to forget especially for old photos. In order to remember it, people have to write notes on the back (or in the front) of the printed photos, or let cameras generate date markers on photos. Writing notes are not applicable for photos in digital formats; camera generated date markers only offer time information. Some people may not be willing to do that since it may ruin the beauty of the picture.

This invention is about to improve the current digital photo reader and frame display experiences by adding a synchronized voice and/or text memo for selected digital photos or video clips. The memo files can also be played/displayed synchronously with the associated content.

### SUMMARY OF THE INVENTION

According to principles of the present invention, a digital content (photo or video clip) file can have an associated audio and/or text file that shares the same prefix file name as the content file but with a different suffix file name. These associated files record either voice or text memos of the selected digital content. The invented digital photo reader/frame can play/display those associated memos while showing the digital content. A voice memo will be played as a background audio, and a text memo will be overlapped with the digital content.

In one embodiment there is provided a digital photo reader/frame system that generates voice and/or text memo files for selected contents (photos or video clips) and synchronously plays/displays the memo files with the associated contents. The system features include: a voice memo processing system, in which a microphone and a voice encoder is used to generate voice memo files; a text memo processing system, in which a soft keyboard and a text organizer is employed to input and format text memo data.

In addition the system also wherein voice and/or text memo files are saved in a predefined memo folder on the same memory where stores the associated content (photo or video) files.

In addition the system also wherein a soft keyboard is a software/firmware module, which is operated via a remote control, a GUI based control, or a touch screen based control.

In a second embodiment there is provided a data accessing method of a digital photo reader/frame system that synchronously plays/displays voice and text memo files with associated digital content (photo or video). When a content (photo or video) file is selected, the invented system will be in its waiting stage for the next control command, which may trigger the following steps:
(1) When a play command is given, the system will jump to step (5); when a voice memo recording command or a text memo input command is issued, continue step (2); if other commands are initiated, go to corresponding control flows;
(2) The system first generates a memo file name, i.e. it takes the same prefix name as the selected content (photo or video) file and adds a correspondent suffix name (depending upon the memo file type and format). If this file name does not exist in the predefined memo folder on the same memory where stores the selected content file, then the system jumps to Step (4); otherwise it takes the next step;
(3) The system prompts the memo file exists and asks for a replacement confirmation. When select to replace the existing file, the system will continue the next step; otherwise, the system will return to Step (1);
(4) The system either starts to record (if a voice memo recording command was issued in Step (1)) or takes text inputs (if a text memo input command was issued in Step (1)) till receiving a stop command. When the voice memo recording or text inputting process is completed, the system saves the memo file (by using the name generated in Step (2)) to the predefined memo folder on the same memory where stores the selected content file, and then returns to Step (1);
(5) The system first checks if it is in a voice and/or text memo mode. If it is not, jump to Step (7); if it is, continue the next step;
(6) The system searches for associated memo files in the predefined memo folder on the same memory where stores the selected content file. The memo files should have the same prefix name as the content file but an audio or text format based suffix name. If such memo files are found, go to Step (8); otherwise continue Step (7);
(7) When neither a memo mode is set nor an associated memo file is found in the predefined memo folder where stores the selected content file, the system will check if a music mode is set. If a music mode is set and music files (excluding those in the predefined memo folder) are found, the system will play the music files as background while displaying/playing content files. Otherwise, the system only displays/plays the selected content file. The system will automatically select the next file on the content list and return to Step (5) when completing displaying/playing the current content, or terminate the content display/play and go back to the waiting stage when receiving a stop command; (8) The system will synchronously playback the voice memo (if a voice memo mode is set and an associated voice memo file is found) as a background voice and/or display the text memo (if a text memo is set and an associated text memo file is found) while the system displaying/playing the selected content. The system will automatically select the next file on the content list and return to Step (5) when completing displaying/playing the current content, or terminate the content display/play and go back to the waiting stage when receiving a stop command;
(9) In any above steps, if other control commands are triggered, the system will jump to corresponding control flows.

In the second embodiment the system may also if a record command is issued when a content (photo or video) file is selected in Step (1), the system will enter a voice memo generation flow. Voice memo files can be recoded via the microphone and the voice recorder; if an input command is issued when a content (photo or video) file is selected in Step (1), the system will enter a text memo generation flow. Text memo files can be input via the soft keyboard module.

In the second embodiment the system may also the voice and text memo files can be generated on personal computers.

In the second embodiment the system may also the memo files stated in Step (6) are those that are associated to a selected content, and that can be synchronously played/displayed with the selected content.

In the second embodiment the system may also when associated text and/or voice memo files are found on the same memory where stores the selected content, the system will enter memo file playing/displaying flow. The voice memo file will be sent to the digital audio decoder by the central controller, and played as a background voice; the text memo file will be fed to the text organizer for adjustment to fit the screen by the central controller. The adjusted text will be sent to the video encoder where it is overlapped with the content (photo or video) data. The overlapped video signal is fed to the video output port and/or sent to the LCD driver to drive the LCD screen.

Numerous other advantages and features of the invention will become readily apparent from the following detailed description of the invention and the embodiments thereof, from the claims, and from the accompanying drawings.

### BRIEF DESCRIPTION OF THE DRAWINGS

FIG. 1 is a conventional digital photo frame system module diagram;

FIG. 2 is a conventional digital photo frame system control and data flow chart;

FIG. 3 is a conventional digital photo frame remote controller buttons;

FIG. 4 is the invented digital photo frame system module diagram;

FIG. 5 is the invented digital photo frame system memo file generation control flow chart;

FIG. 6 is the invented digital photo frame system control and data flow chart;

FIG. 7 is the invented digital photo frame system remote controller buttons;

### DETAILED DESCRIPTION OF THE PREFERRED EMBODIMENT

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or embodiments illustrated.

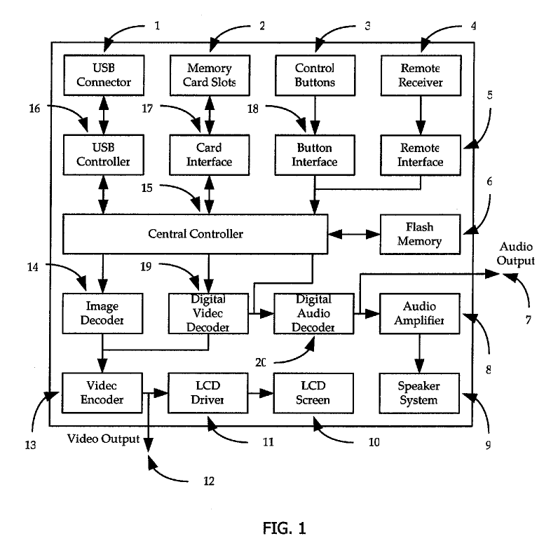

Referring FIG. 1, a typical digital photo reader or frame system has the following components and modules, i.e. USB connector 1, memory card slots 2, on board control buttons 3, remote control receiver 4, central controller 15, image decoder 14, and video encoder 13. For a photo frame, there should have an LCD driver 11 and an LCD screen 10. The USB connector 1 (via USB controller 16) is used for PC to read or write either memory cards via memory card slots 2 or onboard flash memory 6 when USB controller 16 is a slave; it can also be used to read contents on a USB pen drive when USB controller 16 is a host. Memory card slots 2 are designed to be suitable for different type of memory cards, such as MMC, SD, CF, MS, XD, and SM, on which store digital photos, video clips, and audio files. As a minimum requirement, a digital photo reader or frame should have at least a media data input channel, such as a slave USB port plus an onboard flash memory 6, a host USB port, or a memory card slot. It is not necessary to have all of them. Central controller 15 manages the control and data flows among PC (via USB connector 1 and USB controller 16), memory cards (via memory slots 2 and card interface 17), onboard flash memory 6, image decoder 14, digital video decoder 19, audio decoder 20, control buttons 3 (via button interface 18), and remote control (via remote control interface 5). To display photos or video clips, central controller 15 either passes digital photos to image decoder 14 or feeds video clips to digital video decoder 19; the decoded data will be fed into video encoder 13 to generate TV signals. The TV signal will either be used for LCD screen 10 via LCD driver 11 or be sent out via video output jack 12 for other display devices, such as TV sets. To play music/voice files, central controller 15 sends audio data to digital audio decoder 20 and passes decoded signal to audio amplifier 8 for embedded speaker system 9, and/or directly outputs it via audio output jack 7. Note that LCD driver 11, LCD screen 10, audio amplifier 8, and speaker system 9 are only used for photo frame systems.

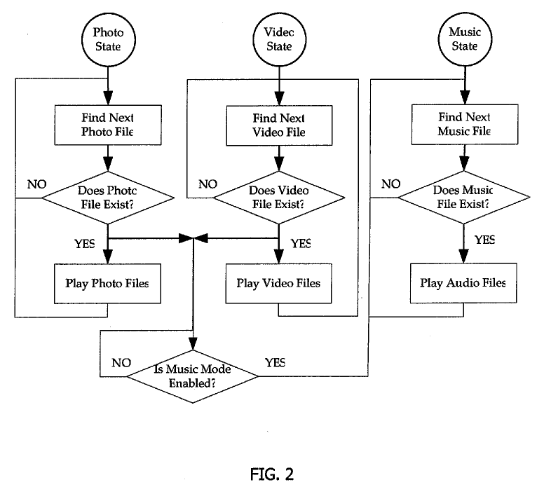

There are two layers in a digital photo reader/frame control flow, i.e. State and Mode. The State defines a system current media type, such as photo, video, and audio; the Mode gives additional media effects under the current state. Referring FIG. 2, when a digital photo reader or a frame is powered on, it will be in one of the three states, i.e. photo, video, and audio. The initial state is the last state when it was powered off. When it is in either a photo or a video state, digital photo or video files will be searched and displayed or played. When a reader/frame is in one of the above states, a music mode can be enabled or disabled. After a music mode is enabled, music files, such as MP3s, will be played in the background while displaying/playing photos or video clips; when the device is in a music state, music files will be searched and played.

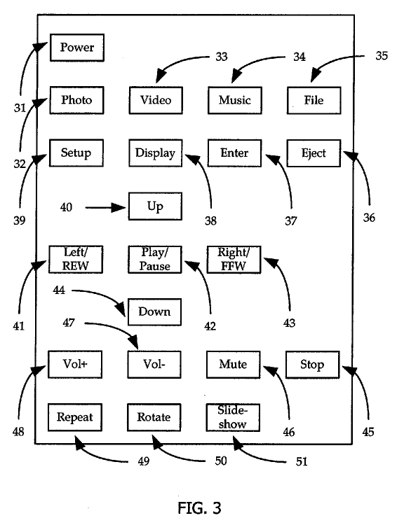

A remote control of a regular digital photo reader or frame is shown in FIG. 3. Button 31 is a power button, which turns a reader or frame on/off; when a photo reader/frame is turned on, button 32, 33 and 34, which represents photo, video, and music states respectively, are used to switch the reader/frame states. If button 32 is pushed, the reader/frame enters a photo state, and a photo file list will be displayed; if button 33 is pushed, it changes to a video state, and a video file list will be displayed; if button 34 is pushed, it switches to a music state, and a music file list will be shown. When a file list is shown in either of the states, button 40, 41, 43, and 44 can be used to navigate the list and select a file, and button 42 is designed to confirm a selected file for displaying/playing. If button 42 is pushed again, a displaying/playing media file will be paused. Button 45 is used to stop a media file display/play; button 46, 47, and 48 are mute, volume down, and volume up buttons; button 49 is used to repeat a currently displaying/playing media file; button 50 and 51 are dedicated for the photo state, where button 50 is for image rotating and button 51 is for slideshow (i.e. display photos based on a predefined order and transmission effects) on/off. Button 35 is designed for file navigations; button 36 is used to eject memory cards and/or USB pen drives; button 37 is used to confirm a selected state, file name, and other setting information; button 39 is used to enter the reader/frame setting menu, such as slideshow orders, transition effects, transition time intervals, and music mode on/off. To reduce the complexity of a remote control, some photo reader/frame uses a graphic user interface (GUI) or a touch screen to conduct most of the controls, but it still provides the same functions that a remote control offers.

In the present invention, a preferred embodiment adds microphone 21, voice encoder 22, soft keyboard 24, and text organizer 23 to a regular digital photo reader/frame system. It enables the reader/frame to record/write and synchronously play/display memo files while associated contents (photos or video clips) are displaying/playing.

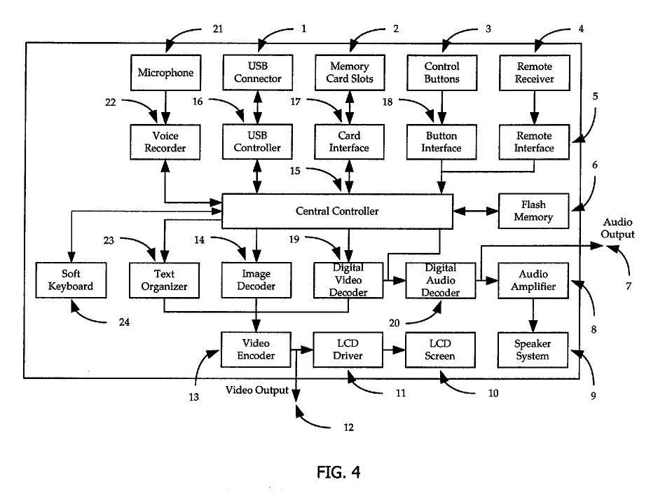

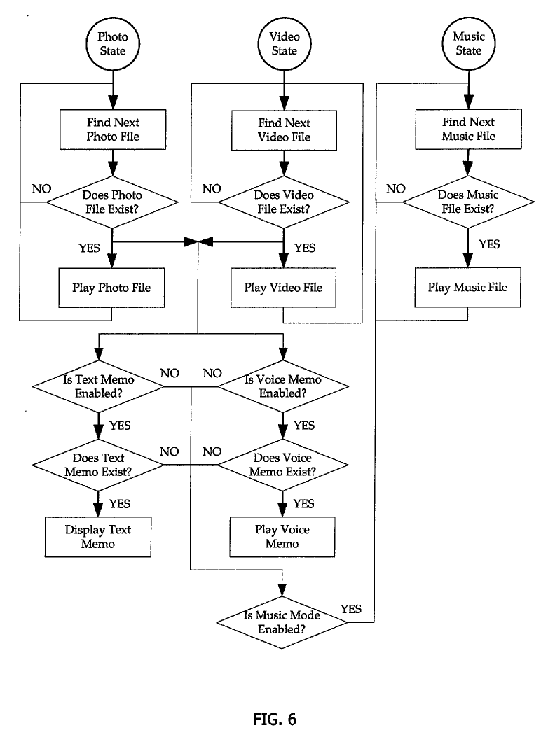

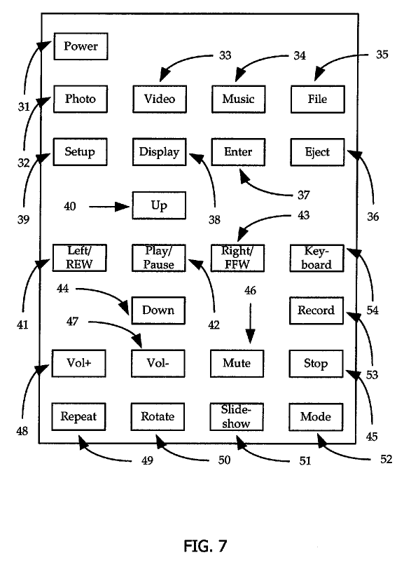

FIG. 4 illustrates the system modules of a digital photo reader/frame in the preferred embodiment. In FIG. 4, microphone 21, voice encoder 22, and soft keyboard module 24 are added to handle both voice and text based memo generations. To record a voice memo, users should select a targeted content (photo or video) file first; and then use the microphone to record a voice memo. The recording process can be invoked by pushing button 53 on the remote control shown in FIG. 7. Central controller 15 (which can be any of the followings, such as, but not limited to, CPU, DSP, MCU, and ASIC) will manage voice encoder 22 to encode the voice signal into a voice file and save the file by using the same prefix name as the content (photo or video) file but with a different suffix name. Note that each file name has two parts, i.e. a prefix part and a suffix part, and they are separated by a dot (“.”). For example, in file name “a bc.txt”, where “abc” is the prefix part of the name, and “txt” is the suffix part. The suffix represents a voice memo file format, which has to be one of the supported formats by the voice recorder. The voice recorder may support more than one voice format, including, but not limited to, MP3, ADPCM, MC, and/or WMA. Then generated voice memo file is saved in a predefined folder on the same memory where stores the associated content file. A voice memo file can also be created via computer programs. As long as it uses the same naming convention and stores in the predefined folder on the same memory where the associated content file is located. To write a text memo, users can either invoke soft keyboard 24 (by pushing button 54 on the remote control shown in FIG. 6) or use a computer based text editor. When input a text memo via the soft keyboard, use button 40, 41, 43, and 44 on the remote control to select letters from the soft keyboard GUI and push button 42 to enter. The text memo file has to be saved by using the same prefix name as the content file but with a text related suffix, such as “txt” or “html”. The file also needs to be saved in the predefined folder on the same memory where stores the associated content file. A predefined folder (such as MEMO), in which stores memo files, is used to distinguish voice memo files from regular music/voice content files (in case they have the same name).

Referring both FIG. 4 and FIG. 6, when the invented photo reader/frame starts to display a photo or play a video clip, it checks if voice and/or text memo modes are enabled. If a voice memo mode is enabled and an associated audio memo file (i.e. the one has the same prefix name as the content file but with a different suffix name) is found in the predefined folder that is on the same memory where stores the content file, the audio memo file will be sent to audio decoder 20 to play. Note that if a voice memo mode is not enabled or an associated voice memo file does not exist, the reader/frame will play music files as background music if a music mode is enabled and music files are located on the same memory where stores the selected content; if the text memo mode is enabled and an associated text memo file (i.e. the one has the same prefix name as the content file but with a different suffix name) is found in the predefined folder that is on the same memory where stores the content file, the text data will be sent to text organizer 23. The text organizer conducts the text rendering based on display settings (i.e. font type, font size, font color, and display mode) and screen profiles. Formatted data is fed into video encoder 13 where it is overlapped with the content data to generate video signals for video output 12 and/or LCD driver 11.

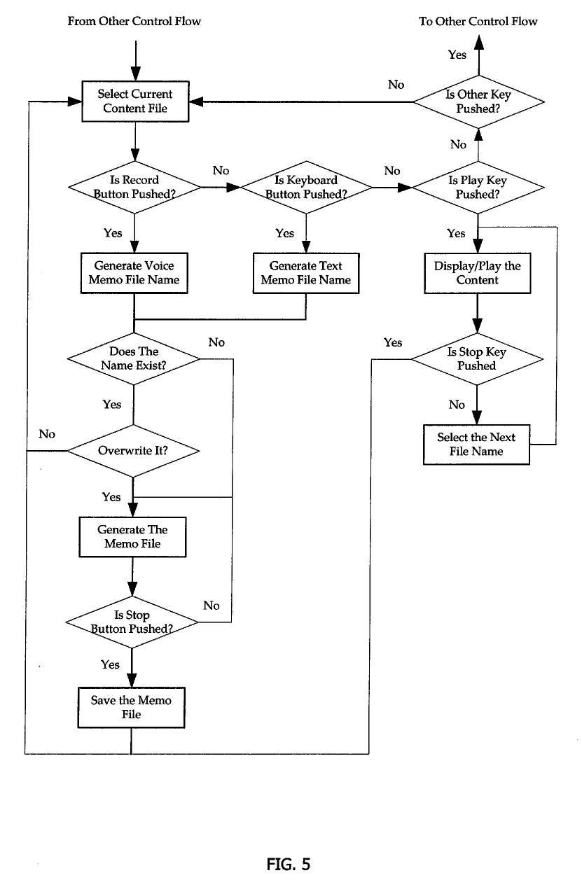

Referring FIG. 5 and FIG. 6, the method for the invented system to generate and playback memo files is stated below. When a content (photo or video) file is selected, the invented system will be in a waiting stage for the next control command, which may trigger the following steps:

(1) When a play command (by pressing play button 42) is given, the system will jump to step (5); when a voice memo record command (by pushing record button 53) or a text memo input command (by pressing keyboard button 54) is issued, continue step (2); if other commands are initiated, go to corresponding control flows;

(2) Now the system is in its memo file generation stage (see FIG. 5). In this stage, the system first generates a memo file name, i.e. it takes the same prefix name as the selected content (photo or video) file and adds a correspondent suffix name (depending upon the memo file type and format). If this file name does not exist in the predefined memo folder on the same memory where stores the selected content file, then the system jumps to Step (4); otherwise it takes the next step;

(3) The system prompts the memo file exists and asks for a replacement confirmation. When select to replace (push enter button 37 or play/pause button 42 to confirm) the existing file, the system will continue the next step; otherwise (push stop button 45 to keep the original memo file), the system will return to Step (1);

(4) The system either starts to record (if record button 53 was pushed in Step (1)) or takes text input (if keyboard button 54 was pushed in Step (1)) till receiving a stop command (i.e. stop button 45 is pushed). When the voice recording or text inputting process is completed, the system saves the memo file (by using the name generated in Step (2)) to the predefined memo folder on the same memory where stores the selected content file, and then returns to Step (1);

(5) Now the system is in its content playback stage (see FIG. 6). It first checks if the system is in a voice and/or text memo mode. If it is not, jump to Step (7); if it is, continue the next step;

(6) The system searches for associated memo files in the predefined memo folder on the same memory where stores the selected content file. The memo files should have the same prefix name as the content file but an audio or text format based suffix name. If such memo files are found, go to Step (8); otherwise continue Step (7);

(7) When neither a memo mode is set nor an associated memo file is found in the predefined memo folder where stores the selected content file, the system will check if a music mode is set. If a music mode is set and music files (excluding those in the predefined memo folder) are found, the system will play the music files as a background while displaying/playing content files. Otherwise, the system only displays/plays the selected content file. The system will automatically select the next file on the content list and return to Step (5) when completing displaying/playing the current content, or terminate the content display/play and go back to the waiting stage when receiving a stop command (by pushing stop button 45);

(8) The system will synchronously play the voice memo (if a voice memo mode is set and an associated voice memo file is found) as a background voice and/or display the text memo (if a text memo is set and an associated text memo file is found) while the system is displaying/playing the selected content. The system will automatically select the next file on the content list and return to Step (5) when completing displaying/playing the current content, or terminate the content display/play and go back to the waiting stage when receiving a stop command (by pushing stop button 45);

(9) In any above steps, if other control commands are triggered, the system will jump to corresponding control flows.

More specifically, as stated in Step (1), if record button 53 is pressed after a content (photo or video) file is selected, the system will enter a voice recording flow, a voice memo file for the selected content will be made directly by the system via microphone 21 and voice encoder 22; if keyboard button 54 is pushed after a content (photo or video) file is selected, the system will enter a text input flow, a text memo file for the selected content will be created directly by the system via soft keyboard module 24.

The memo files mentioned in Step (6) are voice and/or text files that associate with the selected content (photo or video) file, provide voice or text memo for the content, and synchronously display/play with the content.

In the process stated in Step (8), when associated voice and/or text memo files are found on the same memory where stores the selected content (photo or video) file, the system will start to display or play the content; the voice memo file will be sent to digital audio decoder 20 by central controller 15; the text memo file will be sent to text organizer 23 for an on screen display (OSD) adjustment, and then be overlapped with the content data during the video encoding process. The mixed signal will be fed to LCD driver 11 for LCD display or output via video output jack 12.

To control the invented photo reader/frame, referring to FIG. 7, mode button 52, record button 53, and keyboard button 54 are added to a conventional remote control. The mode button is used to switch the mode when the photo reader/frame is in either a photo or a video state. It starts from the “non memo” mode, and circulates in the following mode orders, i.e. “voice memo only” mode, “text memo only” mode, “voice and text memo” mode, and “non memo” mode, when every time the mode button is pushed.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. A digital photo reader/frame system that generates voice and/or text memo files for selected contents (photos or video clips) and synchronously plays/displays the memo files with the associated contents. The system features include: a voice memo processing system, in which a microphone and a voice encoder is used to generate voice memo files; a text memo processing system, in which a soft keyboard and a text organizer is employed to input and format text memo data.

2. The system of claim 1, wherein voice and/or text memo files are saved in a predefined memo folder on the same memory where stores the associated content (photo or video) files.

3. The system of claim 1, wherein a soft keyboard is a software/firmware module, which is operated via a remote control, a GUI based control, or a touch screen based control.

4. A data accessing method of a digital photo reader/frame system that synchronously plays/displays voice and text memo files with associated digital content (photo or video). When a content (photo or video) file is selected, the invented system will be in its waiting stage for the next control command, which may trigger the following steps:
(1) When a play command is given, the system will jump to step (5); when a voice memo recording command or a text memo input command is issued, continue step (2); if other commands are initiated, go to corresponding control flows;
(2) The system first generates a memo file name, i.e. it takes the same prefix name as the selected content (photo or video) file and adds a correspondent suffix name (depending upon the memo file type and format). If this file name does not exist in the predefined memo folder on the same memory where stores the selected content file, then the system jumps to Step (4); otherwise it takes the next step;
(3) The system prompts the memo file exists and asks for a replacement confirmation. When select to replace the existing file, the system will continue the next step; otherwise, the system will return to Step (1);
(4) The system either starts to record (if a voice memo recording command was issued in Step (1)) or takes text inputs (if a text memo input command was issued in Step (1)) till receiving a stop command. When the voice memo recording or text inputting process is completed, the system saves the memo file (by using the name generated in Step (2)) to the predefined memo folder on the same memory where stores the selected content file, and then returns to Step (1);
(5) The system first checks if it is in a voice and/or text memo mode. If it is not, jump to Step (7); if it is, continue the next step;
(6) The system searches for associated memo files in the predefined memo folder on the same memory where stores the selected content file. The memo files should have the same prefix name as the content file but an audio or text format based suffix name. If such memo files are found, go to Step (8); otherwise continue Step (7);
(7) When neither a memo mode is set nor an associated memo file is found in the predefined memo folder where stores the selected content file, the system will check if a music mode is set. If a music mode is set and music files (excluding those in the predefined memo folder) are found, the system will play the music files as background while displaying/playing content files. Otherwise, the system only displays/plays the selected content file. The system will automatically select the next file on the content list and return to Step (5) when completing displaying/playing the current content, or terminate the content display/play and go back to the waiting stage when receiving a stop command;
(8) The system will synchronously playback the voice memo (if a voice memo mode is set and an associated voice memo file is found) as a background voice and/or display the text memo (if a text memo is set and an associated text memo file is found) while the system displaying/playing the selected content.
The system will automatically select the next file on the content list and return to Step (5) when completing displaying/playing the current content, or terminate the content display/play and go back to the waiting stage when receiving a stop command;
(9) In any above steps, if other control commands are triggered, the system will jump to corresponding control flows.

5. The method of claim 4, wherein if a record command is issued when a content (photo or video) file is selected in Step (1), the system will enter a voice memo generation flow. Voice memo files can be recoded via the microphone and the voice recorder; if an input command is issued when a content (photo or video) file is selected in Step (1), the system will enter a text memo generation flow. Text memo files can be input via the soft keyboard module.

6. The method of claim 4, wherein the voice and text memo files can be generated on personal computers.

7. The method of claim 4, wherein the memo files stated in Step (6) are those that are associated to a selected content, and that can be synchronously played/displayed with the selected content.

8. The method of claim 4, wherein when associated text and/or voice memo files are found on the same memory where stores the selected content, the system will enter memo file playing/displaying flow. The voice memo file will be sent to the digital audio decoder by the central controller, and played as a background voice; the text memo file will be fed to the text organizer for adjustment to fit the screen by the central controller. The adjusted text will be sent to the video encoder where it is overlapped with the content (photo or video) data. The overlapped video signal is fed to the video output port and/or sent to the LCD driver to drive the LCD screen.
